(19) United States
(12) Patent Application Publication
(10) Pub. No.: US 2024/0329343 A1
(43) Pub. Date: Oct. 3, 2024

(54) PHOTOELECTRIC COMPOSITE TRANSMISSION MODULE AND OPTICAL COMMUNICATION CABLE USING PHOTOELECTRIC COMPOSITE TRANSMISSION MODULE

(71) Applicant: NITTO DENKO CORPORATION, Osaka (JP)

(72) Inventors: Atsushi Yamagishi, Ibaraki-shi (JP); Masataka Yamaji, Ibaraki-shi (JP); Naoto Konegawa, Ibaraki-shi (JP)

(73) Assignee: NITTO DENKO CORPORATION, Osaka (JP)

(21) Appl. No.: 18/611,939

(22) Filed: Mar. 21, 2024

(30) Foreign Application Priority Data
Mar. 29, 2023 (JP) 2023-053950
Mar. 29, 2023 (JP) 2023-053951

(51) Int. Cl. G02B 6/42

(52) U.S. Cl. CPC G02B 6/4278; G02B 6/4257; G02B 6/4269; G02B 6/4281

(57) ABSTRACT

A photoelectric composite transmission module includes: a photoelectric hybrid substrate including: the substrate; a photoelectric conversion unit on a first surface of the substrate; and an optical waveguide provided on a second surface of the substrate; a first housing on one surface side of the photoelectric hybrid substrate, the one surface side corresponding to a surface of the photoelectric hybrid substrate on which the photoelectric conversion unit is provided; a second housing on the other surface side of the photoelectric hybrid substrate, the other surface side corresponding to a surface of the photoelectric hybrid substrate on which the optical waveguide is provided; and a heat-transfer member provided between the surface of the photoelectric hybrid substrate on which the photoelectric conversion unit is provided and the first housing. The photoelectric conversion unit is covered with resin. A surface of the resin and the first housing abut the heat-transfer member.

### TECHNICAL FIELD

The present disclosure relates to a photoelectric composite transmission module and an optical communication cable using the photoelectric composite transmission module. More specifically, the present disclosure relates to a photoelectric composite transmission module that is capable of efficiently dissipating heat from a photoelectric conversion unit, and furthermore, that is reduced in thickness and weight, and an optical communication cable using the photoelectric composite transmission module.

In recent years, due to the increase in the amount of information transmitted, a photoelectric hybrid substrate that uses optical wiring in addition to electric wiring has been widely used for electronic devices. Such a photoelectric hybrid substrate includes a photoelectric converter for performing conversion between an electric signal and an optical signal, and can thereby be used as, for example, a photoelectric composite transmission module that converts an optical signal input from a hybrid cable into an electric signal, and outputs the electric signal to a blade server, converts an electric signal input from the blade server into an optical signal, and outputs the optical signal to the hybrid cable.

The photoelectric converter produces heat with the operation thereof and has an elevated temperature (for example, 70° C. or more). In particular, a drive integrated circuit (IC) and a trans impedance amplifier (TIA) produce a large amount of heat. When heat emitted from the photoelectric converter is accumulated in a case (housing) of the photoelectric composite transmission module, the temperature inside the housing is elevated. As a result, there is a case where a malfunction of a light-emitting element and a light-receiving element occurs, and deformation of a flexible printed circuit (FPC) or the like occurs, which leads to a failure of the photoelectric composite transmission module.

To solve such a problem, PTL 1 proposed a photoelectric composite transmission module. This photoelectric composite transmission module not only includes a printed substrate, an optical waveguide, an FPC, a photoelectric converter, and a heat dissipation sheet, but also includes a housing provided with a protrusion that protrudes toward one side of a thickness direction. By applying pressure to the heat dissipation sheet downward with the protrusion of the housing, the heat dissipation sheet is brought into intimate contact with the photoelectric converter, heat produced from the photoelectric converter is transmitted to the protrusion of the housing via the heat dissipation sheet, whereby heat is dissipated.

However, although the photoelectric composite transmission module according to PTL 1 is expected to provide a heat dissipation effect to some extent, the protrusion needs to be provided inside the housing so that there is a problem that the photoelectric composite transmission module becomes bulky as a whole by an amount of the protrusion and is difficult to be reduced in thickness. In addition, since the photoelectric composite transmission module has a configuration in which the light-emitting element and the light-receiving element are installed immediately below the protrusion inside the housing, there is a possibility that the protrusion of the housing comes in contact with the light-emitting element and the light-receiving element at the time of manufacturing or use. Thus is also a problem that the light-emitting element and the light-receiving element are subject to damage.

### RELATED ART DOCUMENT

### Patent Document

PTL 1: JP2015-22129A

### SUMMARY

### PROBLEMS TO BE SOLVED BY THE DISCLOSURE

Based on such circumstances, an aspect of the present disclosure is to provide a photoelectric composite transmission module that is reduced in thickness, size, and weight, that is capable of preventing damage on a photoelectric conversion unit. A further aspect of the present disclosure is to provides an enhanced heat dissipation effect, and an optical communication cable using the photoelectric composite transmission module.

### Means for Solving the Problems

The inventors have found, as a result of intensive research, that when a photoelectric conversion unit is covered with resin, and the resin and a housing are brought into contact with a heat-transfer member, whereby heat can be sufficiently dissipated, there is no need for providing a protrusion inside the housing.

Embodiments of the present disclosure include the following aspects:

### First Aspect

That is, the present disclosure includes a first aspect as described in the following [1] to [10].

[1] A photoelectric composite transmission module including:
a photoelectric hybrid substrate including:
   a substrate;
   a photoelectric conversion unit provided on a first surface of the substrate; and
   an optical waveguide provided on a second surface of the substrate;
a first housing that protects one surface side of the photoelectric hybrid substrate, the one surface side corresponding to a surface of the photoelectric hybrid substrate on which the photoelectric conversion unit is provided;
a second housing that protects the other surface side of the photoelectric hybrid substrate, the other surface side corresponding to a surface of the photoelectric hybrid substrate on which the optical waveguide is provided; and
a heat-transfer member provided between the surface of the photoelectric hybrid substrate on which the photoelectric conversion unit is provided and the first housing,
wherein
the photoelectric conversion unit provided on the first surface of the substrate is covered with resin, and
a surface of the resin facing the first housing and the first housing are in contact with the heat-transfer member.

[2] The photoelectric composite transmission module according to [1], wherein
the photoelectric hybrid substrate further includes a wiring pattern that transmits an electric signal from the photoelectric conversion unit or transmits an electric signal to the photoelectric conversion unit, and
the heat-transfer member is also in contact with at least part of the wiring pattern.

[3] The photoelectric composite transmission module according to [1] or [2], wherein the heat-transfer member is in contact with a whole of the surface of the resin facing the first housing.

[4] The photoelectric composite transmission module according to any one of [1] to [3], wherein a surface of the first housing facing the photoelectric hybrid substrate is formed as a flat surface.

[5] The photoelectric composite transmission module according to any one of [1] to [4], wherein the photoelectric conversion unit on the photoelectric hybrid substrate includes a combination of a light-emitting element and a drive integrated circuit that drives the light-emitting element and/or a combination of a light-receiving element and a trans impedance amplifier.

[6] The photoelectric composite transmission module according to any one of [1] to [5], wherein the heat-transfer member is made of a material with heat conductivity of 20 W/mk or less.

[7] The photoelectric composite transmission module according to any one of [1] to [6], wherein the heat-transfer member is a heat dissipation sheet with an Asker C hardness of 40 or less.

[8] The photoelectric composite transmission module according to any one of [1] to [7], wherein an Asker C hardness P of the heat-transfer member, an Asker C hardness Q of the resin, and an Asker C hardness R of the photoelectric conversion unit are in a relationship shown in the following Expression (1).

$$P < Q < R \qquad ( 1 )$$

[9] The photoelectric composite transmission module according to any one of [1] to [8], wherein each of the first housing and the second housing is made of metal.

[10] An optical communication cable using the photoelectric composite transmission module according to any one of [1] to [9], the optical communication cable including:
the photoelectric composite transmission module; and
a hybrid cable connected to the photoelectric composite transmission module.

### Second Aspect

In addition, the present disclosure includes a second aspect as described in the following to [22].

A photoelectric composite transmission module including:
a photoelectric hybrid substrate including:
   a substrate;
   a photoelectric conversion unit provided on a first surface of the substrate; and
   an optical waveguide provided on a second surface of the substrate;
a first housing that protects one surface side of the photoelectric hybrid substrate, the one surface side corresponding to a surface of the photoelectric hybrid substrate on which the photoelectric conversion unit is provided;
a second housing that protects the other surface side of the photoelectric hybrid substrate, the other surface side corresponding to a surface of the photoelectric hybrid substrate on which the optical waveguide is provided; and
a heat-transfer member provided between the surface of the photoelectric hybrid substrate on which the photoelectric conversion unit is provided and the first housing,
wherein
the photoelectric conversion unit provided on the first surface of the substrate is covered with resin,
a frame wall that serves as an installation guide for the heat-transfer member is provided on an internal surface of the first housing,
the heat-transfer member is installed in a region surrounded by the frame wall, and
a surface of the resin facing the first housing is in contact with the first housing via the heat-transfer member.

[12] The photoelectric composite transmission module according to [11], wherein a height A of the frame wall and a distance B from the internal surface of the first housing in the region surrounded by the frame wall to the surface of the resin facing the first housing are designed to satisfy the following Expression (4).

$$0.2 \leq ( A / B ) \leq 0.7 \qquad ( 4 )$$

[13] The photoelectric composite transmission module according to or [12], wherein a height A of the frame wall and a distance D from the internal surface of the first housing in the region surrounded by the frame wall to the substrate are designed to satisfy the following Expression (2).

$$0.1 \leq ( A / D ) \leq 0.5 \qquad ( 2 )$$

[14] The photoelectric composite transmission module according to any one of to [13], wherein a distance B from the internal surface of the first housing in the region surrounded by the frame wall to the surface of the resin facing the first housing and a distance C from the substrate to the surface of the resin facing the first housing are designed to satisfy the following Expression (3).

$$2 \leq ( B / C ) \leq 3 \qquad ( 3 )$$

[15] The photoelectric composite transmission module according to any one of to [14], wherein a heat dissipation sheet with an Asker C hardness of 40 or less is used as the heat-transfer member.

[16] The photoelectric composite transmission module according to any one of to [15], wherein
the photoelectric conversion unit includes a light-emitting element and a drive integrated circuit, and
the region surrounded by the frame wall on the internal surface of the first housing is provided in a portion of the photoelectric conversion unit facing at least the drive integrated circuit.

[17] The photoelectric composite transmission module according to [16], wherein an area of the region surrounded by the frame wall on the internal surface of the first housing is designed to be 95% or more of an area when viewed from vertically above the drive integrated circuit in the photoelectric conversion unit and designed to be 110% or less of an area when viewed from vertically above the photoelectric hybrid substrate.

[18] The photoelectric composite transmission module according to any one of to [15], wherein
the photoelectric conversion unit includes a light-receiving element and a trans impedance amplifier, and
the region surrounded by the frame wall on the internal surface of the first housing is provided in a portion of the photoelectric conversion unit facing at least the trans impedance amplifier.

[19] The photoelectric composite transmission module according to [18], wherein an area of the region surrounded by the frame wall on the internal surface of the first housing is designed to be 95% or more of an area when viewed from vertically above the trans impedance amplifier in the photoelectric conversion unit and designed to be 110% or less of an area when viewed from vertically above the photoelectric hybrid substrate.

[20] The photoelectric composite transmission module according to any one of to [19], wherein
an external thickness of a housing formed of the first housing and the second housing is designed to be different between a first end side and a second end side (in other words, a facing distance between the first housing and the second housing is designed so that the first end side is shorter than the second end side, or the second end side is shorter than the first end side),
the first housing is provided with a first displacement portion to change a facing distance, and
the heat-transfer member is installed in the first displacement portion.

[21] The photoelectric composite transmission module according to [20], wherein

the second housing is provided with a second displacement portion to change a facing distance, and
the second displacement portion is provided at a position facing the first displacement portion provided in the first housing.

[22] An optical communication cable using the photoelectric composite transmission module according to any one of to [21], the optical communication cable including:
the photoelectric composite transmission module; and
a hybrid cable connected the photoelectric composite transmission module.

### EFFECTS OF THE DISCLOSURE

Embodiments of the present disclosure enable a reduction in thickness, size, and weight, while also enables the prevention of damage on a photoelectric conversion unit, and furthermore, enables efficient dissipation of heat produced from the photoelectric conversion unit.

In addition, the provision of an installation guide in a housing and the designation of an attachment position of a heat-transfer member can improve efficiency of an operation of attaching the heat-transfer member. Since the installation of the heat-transfer member in a region surrounded by the installation guide can infallibly prevent the heat-transfer member from protruding, it is possible to prevent occurrence of a malfunction such as application of stress to an edge of a printed circuit board (PCB) by the protruded heat-transfer member. Furthermore, since it is possible to efficiently dissipate heat from the photoelectric conversion unit, the present disclosure implements a reduction in thickness, size, and weight, and also provides excellent design.

### BRIEF DESCRIPTION OF DRAWINGS

FIG. 1 is a perspective view illustrating an outer appearance of a photoelectric composite transmission module according to a first aspect as one of embodiments of the present disclosure.

FIG. 2 is an exploded perspective view illustrating a configuration of the photoelectric composite transmission module according to the first aspect as one of the embodiments of the present disclosure.

FIG. 3 is a partial sectional view for describing an internal configuration of the photoelectric composite transmission module according to the first aspect as one of the embodiments of the present disclosure.

FIG. 4 is a schematic view for describing a main configuration of the photoelectric composite transmission module according to the first aspect as one of the embodiments of the present disclosure.

FIG. 5 is a cross-sectional view along X-X′ illustrated in FIG. 4.

FIG. 6 is a schematic view for describing a main configuration of the photoelectric composite transmission module according to the first aspect as one of the embodiments of the present disclosure.

FIG. 7 is a view for describing a location where a heat-transfer member is installed in the photoelectric composite transmission module according to the first aspect as one of the embodiments of the present disclosure.

FIG. 8 is a view for describing a location where a heat-transfer member is installed according to Example 1 and Comparative Examples 1 to 3.

FIG. 9 is a view for describing a size of a heat-transfer member and a location where the heat-transfer member is installed according to Examples 2 to 5.

FIG. 10 is a graph indicating results of measuring a temperature of a housing according to Examples 2 to 5.

FIG. 11 is a perspective view illustrating an outer appearance of a photoelectric composite transmission module according to a second aspect as one of the embodiments of the present disclosure.

FIG. 12 is a perspective view illustrating the outer appearance of the photoelectric composite transmission module according to the second aspect as one of the embodiments of the present disclosure when viewed from a different direction.

FIG. 13 is a front view illustrating the outer appearance of the photoelectric composite transmission module according to the second aspect as one of the embodiments of the present disclosure when viewed from the front side.

FIG. 14 is a plan view illustrating the outer appearance of the photoelectric composite transmission module according to the second aspect as one of the embodiments of the present disclosure when viewed from the above.

FIG. 15 is a right-side view illustrating the outer appearance of the photoelectric composite transmission module according to the second aspect as one of the embodiments of the present disclosure when viewed from the right side.

FIG. 16 is a cross-sectional view along L-L in which part of an internal structure of the photoelectric composite transmission module illustrated in FIG. 15 is omitted.

FIG. 17 is an exploded perspective view illustrating a configuration of the photoelectric composite transmission module according to the second aspect as one of the embodiments of the present disclosure.

FIG. 18 is a partial sectional view for describing an internal configuration of the photoelectric composite transmission module according to the second aspect as one of the embodiments of the present disclosure in a partially omitted manner.

FIG. 19 is a plan view illustrating a first housing when viewed from the inside thereof.

FIG. 20 is a cross-sectional view along M-M illustrated in FIG. 19.

FIG. 21A and FIG. 21B are both views for describing a frame wall provided in the first housing and a region surrounded by the frame wall.

FIG. 22 is a schematic view for describing a main configuration of the photoelectric composite transmission module according to the second aspect as one of the embodiments of the present disclosure.

FIG. 23A is a view for describing the frame wall provided in the first housing, and an area ratio of the region surrounded by the frame wall, a drive integrated circuit, and a photoelectric hybrid substrate. FIG. 23B is a view for describing the frame wall provided in the first housing, an area ratio of the region surrounded by the frame wall, a trans impedance amplifier, and the photoelectric hybrid substrate.

### EMBODIMENTS OF THE DISCLOSURE

The present disclosure will be described below based on examples of embodiments for implementing the present disclosure. However, the present disclosure is not limited to the following embodiments.

In the present disclosure, in a case where an expression of “L or more” (L is a freely-selected number) or “M or less” (M is a freely-selected number) is used, the expression also includes the meaning that “preferably more than L” or “preferably less than M”.

Additionally, in the present disclosure, “L and/or M (L and M are freely-selected components)” means at least one of L or M, and means three possible patterns of only L, only M, and L and M.

Furthermore, in the present disclosure, “L and M are in contact with each other (L and M are freely-selected components)” means two possible patterns of a case where L and M are in direct contact with each other and a case where L and M are in indirect contact with each other via another member).

### First Aspect

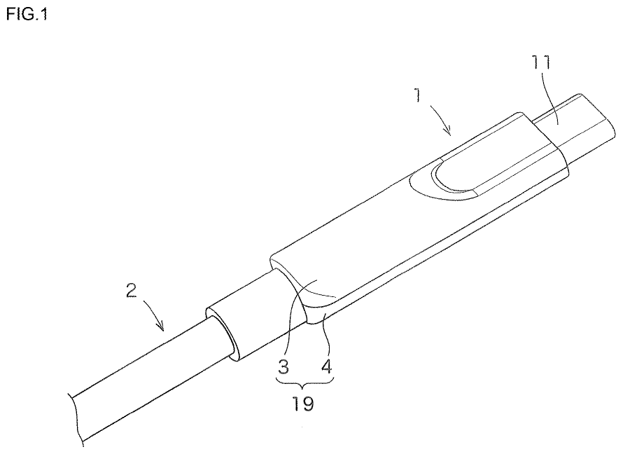

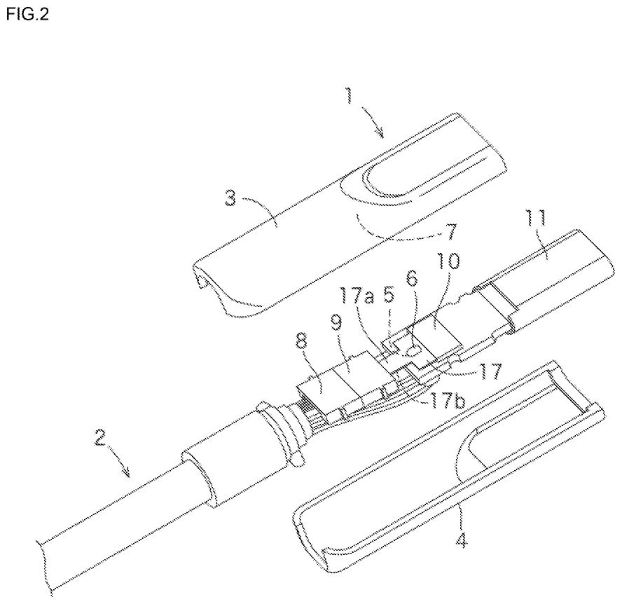

FIG. 1 is a perspective view illustrating an outer appearance of a photoelectric composite transmission module 1 according to a first aspect as one of the embodiments of the present disclosure. FIG. 2 is an exploded perspective view illustrating a configuration of the photoelectric composite transmission module 1.

The photoelectric composite transmission module 1 according to the first aspect of the present disclosure converts light output from a hybrid cable 2 into electricity, inputs the electricity to an electrical device (not illustrated), converts electricity output from the electrical device (not illustrated) into light, and inputs the light to the hybrid cable 2. Note that FIG. 2 illustrates a mechanical transfer (MT) optical connector 8, a polymer mechanical transfer (PMT) optical connector 9, a zero-insertion-force (ZIF) connector 10, and a plug 11. Examples of the plug mentioned herein include a type-C plug and a high-definition multimedia interface (HDMI) (registered trademark) plug.

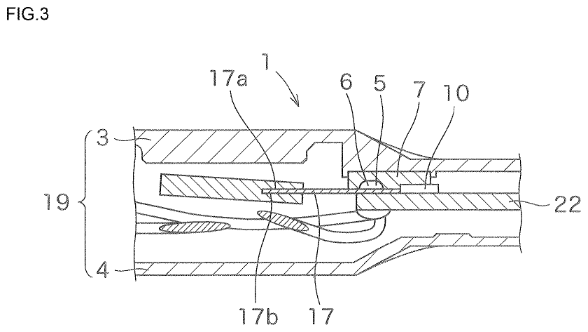

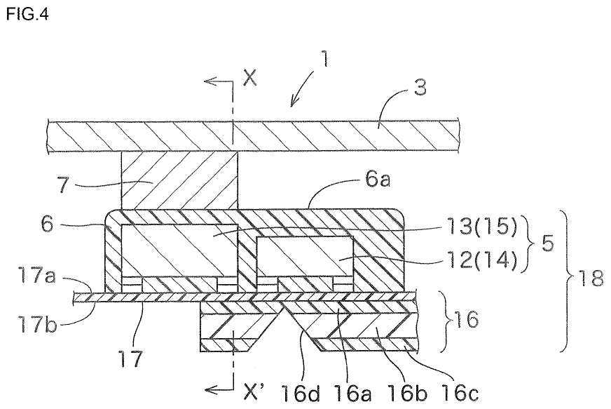

The photoelectric composite transmission module 1 according to the first aspect of the present disclosure includes, as illustrated in FIG. 3, a photoelectric hybrid substrate 18 (refer to FIG. 4), a PCB 22, the ZIF connector 10, a first housing 3, a second housing 4, and a heat-transfer member 7. The photoelectric hybrid substrate 18 includes a substrate 17, a photoelectric conversion unit 5, and an optical waveguide 16. The ZIF connector 10 connects the photoelectric hybrid substrate 18 and the PCB 22. The heat-transfer member 7 is provided between the surface of the photoelectric hybrid substrate 18 on which the photoelectric conversion unit 5 is provided and the first housing 3.

In addition, as illustrated in FIGS. 4 and 5, the photoelectric conversion unit 5 is covered with resin 6, and a surface 6a of the resin 6 facing the first housing 3 and the first housing 3 are in contact with the heat-transfer member 7. Details of these components will be described below.

### Photoelectric Hybrid Substrate

The photoelectric hybrid substrate 18 includes the substrate 17, the photoelectric conversion unit 5 provided on a first surface 17a of the substrate 17, and the optical waveguide 16 provided on a second surface 17b of the substrate 17.

The photoelectric conversion unit 5 and a wiring pattern 20 (refer to FIG. 8) connected to the photoelectric conversion unit 5 are provided on the first surface 17a of the substrate 17.

The substrate 17 is, for example, a flexible printed substrate (FPC). Examples of this substrate include a substrate obtained by hardening glass fabrics/glass non-woven fabrics with epoxy resin (for example, CEM-3 or the like), and a substrate obtained by hardening glass fabrics with epoxy resin (for example, FR-4, FR-5, or the like), metal, polytetrafluoroethylene (PTFE), polyimide, or the like. In addition, the thickness of the substrate is, for example, 20 μm or more and 200 μm or less.

The wiring pattern 20 (refer to FIG. 8) connected to the photoelectric conversion unit 5 is provided on the first surface 17a of the substrate 17. The wiring pattern 20 is typically made of copper. For example, on a light-receiving side (Rx), a light-receiving element 14, and a trans impedance amplifier (hereinafter may be referred to as a “TIA”) 15 are connected to each other by the wiring pattern 20. In addition, the TIA 15 and the ZIF connector 10 are connected to each other by the wiring pattern 20. On a light-emitting side (Tx), a light-emitting element 12 and a drive integrated circuit (hereinafter may be referred to as “drive IC”) 13 are connected to each other by the wiring pattern 20. The drive IC 13 and the ZIF connector 10 are connected to each other by the wiring pattern 20. The above-mentioned wiring pattern 20 is provided on the first surface 17a of the substrate 17. Note that FIG. 8 illustrates only a main portion of the wiring pattern 20.

The photoelectric conversion unit 5 provided on the first surface 17a of the substrate 17 includes a plurality of members that converts light into electricity or converts electricity into light. For example, a combination of the light-receiving element 14 and the TIA 15 is preferably used on the light-receiving side (Rx), while a combination of the light-emitting element 12 and the drive IC 13 is preferably used on the light-emitting side (Tx). The light-emitting element 12 converts electricity into light.

Specific examples of the light-emitting element 12 include a surface emitting diode (vertical-cavity surface-emitting laser (VCSEL)). The drive IC 13 electrically connected to the light-emitting element 12 is installed in the vicinity of the light-emitting element 12.

The light-receiving element 14 converts light into electricity. Specific examples of the light-receiving element 14 include a photodiode (PD). The TIA 15 electrically connected to the light-receiving element 14 is installed in the vicinity of the light-receiving element 14.

In the photoelectric conversion unit 5, on the light-emitting side (Tx), the drive IC 13 converts an electric signal input from the wiring pattern 20 to the drive IC 13 so as to satisfy a predetermined drive condition, and the light-emitting element 12 converts the converted electric signal into light and emits the light toward a mirror 16d in the optical waveguide 16.

On the light-receiving side (Rx), the light-receiving element 14 electrically converts light input from the mirror 16d in the optical waveguide 16 to the light-receiving element 14 into electricity, and the TIA 15 amplifies the electricity and inputs the amplified electricity to the wiring pattern 20 (refer to FIG. 8).

In this manner, the photoelectric conversion unit 5 is capable of performing conversion between electricity and light.

The photoelectric conversion unit 5 includes an electrode (not illustrated), and is mounted on the substrate 17 so as to be electrically connected to a terminal (not illustrated) of the substrate 17 via a bump (not illustrated).

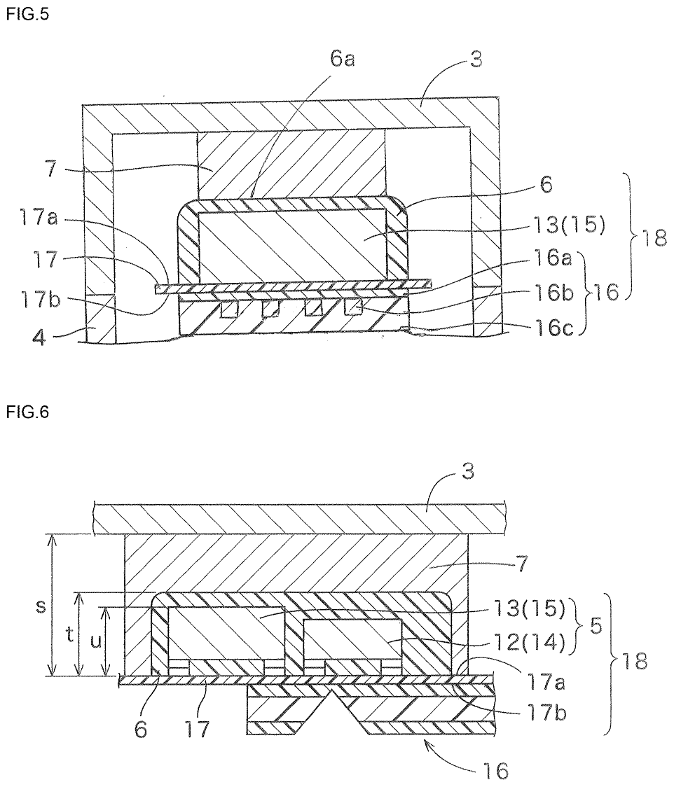

The optical waveguide 16 is provided on the second surface 17b of the substrate 17 (refer to FIG. 6).

The optical waveguide 16 has a substantially sheet-like shape that extends in a longitudinal direction, and includes an under-cladding layer 16a, a core layer 16b, and an over-cladding layer 16c. The mirror 16d is formed at an end portion of the core layer 16b in the longitudinal direction. Examples of a material of the optical waveguide 16 include a transparent material such as epoxy resin. The thickness of the optical waveguide 16 is set, for example, between 20 μm or more and 200 μm or less.

The thickness of the photoelectric hybrid substrate 18 including these components is, typically, 25 μm or more and 500 μm or less, and is preferably 40 μm or more and 250 μm or less in terms of excellence in balance between the reduction in thickness and ease of handling.

### Resin

The photoelectric conversion unit 5 provided on the first surface 17a of the substrate 17 is covered with the resin 6.

The thickness of the resin 6 is not specifically limited, but is preferably 100 μm or more and 500 μm or less, more preferably 150 μm or more and 300 μm or less in terms of infallible protection of the photoelectric conversion unit 5 and the reduction in thickness of the photoelectric composite transmission module 1 according to the first aspect.

Note that the thickness of the resin 6 is assumed to be a distance from the first surface 17a of the substrate 17 to the highest location of the resin 6 as indicated by a reference sign t in FIG. 6.

As the material of the resin 6, for example, a material having heat conductivity (W/mK) of 0.1 W/mK or more and 3 W/mK or less, more preferably 0.1 W/mK or more and 1 W/mK or less, in terms of excellence in balance between a heat dissipation effect, adhesiveness, heat resistance, and light transmissivity. Examples of such a material include epoxy resin and acrylic resin, and especially, the epoxy resin is preferably used in terms of excellence especially in combination with the heat-transfer member 7.

### First Housing and Second Housing

The first housing 3 that protects a surface side of the photoelectric hybrid substrate 18 on which the photoelectric conversion unit 5 is provided can constitute, in combination with the second housing 4 that pairs up with the first housing 3, a case 19 that has a substantially box shape and that houses the photoelectric hybrid substrate 18 (refer to FIG. 1).

The first housing 3 and the second housing 4 (hereinafter may be referred to as “the first housing 3 or the like”) are preferably made of a material having as high heat conductivity as possible in consideration of the heat dissipation effect, especially a material having heat conductivity of 50 W/mK or more.

The first housing 3 and the second housing 4 are more preferably made of metal in terms of high heat conductivity, high strength, and compatibility with the heat dissipation effect and protection of the inside (the photoelectric conversion unit 5 and the like). Specific examples of the metal material include aluminum, copper, silver, zinc, nickel, chrome, titanium, tantalum, platinum, gold, and an alloy thereof (red brass, stainless-steel, and the like). Each of these materials can be used alone or two or more types thereof can be used in combination. In terms of surface protection and aesthetic merit, the first housing 3 or the like may be subjected to surface processing such as plate processing.

As the thickness of the first housing 3 or the like increases, the heat dissipation effect increases, but the weight also increases. Thus, the thickness of the first housing 3 or the like is preferably 0.1 mm or more and 0.6 mm or less, more preferably 0.2 mm or more and 0.5 mm or less in consideration of balance between the heat dissipation effect and the reduction in weight.

Note that it can also be considered that the increase in thickness of the first housing 3 or the like does not enhance the heat dissipation effect because heat dissipates sufficiently in the longitudinal direction. However, since the area in contact with an external space increases, it can be considered that the heat dissipation effect is enhanced natural-logarithmically.

Since a protrusion that protrudes toward the inside (the photoelectric hybrid substrate 18 side) is not provided on the internal side surface of the first housing 3 or the like, the inside of the first housing 3 or the like is formed as a flat surface.

In the present disclosure, “formed as a flat surface” means that a protrusion is intentionally not provided, specifically, a protrusion with a height of 4 mm or more is not provided on the internal surface of the first housing 3 or the like.

This configuration can save an internal space of the case 19 formed by a combination of the first housing 3 and the second housing 4 by absence of the protrusion, and can implement the reduction in thickness, size, and weight of the photoelectric composite transmission module 1 according to the first aspect.

Further, the distance from the photoelectric conversion unit 5 to the first housing 3 can be shortened by the absence of the protrusion, allowing a more enhanced heat dissipation effect.

Since the protrusion that protrudes toward the internal surface is not formed, the photoelectric conversion unit 5 is not damaged by the protrusion when the first housing 3 or the like is attached to the photoelectric hybrid substrate 18, when the photoelectric conversion unit 5 is subjected to shock from the outside, or other cases.

### Heat-Transfer Member

As the heat-transfer member 7 provided between the surface of the photoelectric hybrid substrate 18 on which the photoelectric conversion unit 5 is provided and the first housing 3, it is possible to use a heat-transfer member that is expected to provide the heat dissipation effect by being brought into contact with the surface 6a of the resin 6 facing the first housing 3 and the first housing 3.

That is, the reason for the above is that with the enhanced heat dissipation effect, it is possible to further reduce thermal noise from the drive IC 13 and the TIA 15 and further increase the output of the light-emitting element such as the VCSEL and the light-receiving element.

As the heat-transfer member 7, for example, a heat dissipation sheet, a heat dissipation grease, a heat dissipation plate, or the like can be used.

Examples of the heat dissipation sheet include a filler resin composition in which a filler such as alumina (aluminum oxide), boron nitride, zinc oxide, aluminum hydroxide, molten silica, magnesium oxide, and aluminum nitride is dispersed into base resin such as silicone resin, epoxy resin, acrylic resin, and urethane resin. Each of these materials can be used alone or two or more types thereof can be used in combination.

Among these materials, a material that uses silicone resin is preferably used as the base resin in terms of excellence in balance among an insulation property, adhesiveness, and heat conductivity.

The heat dissipation sheet is preferably made of a material having excellent flexibility from a point that it can be in more intimate contact with the surface 6a of the resin 6 facing the first housing 3 and the first housing 3. For a similar reason, it is preferable that the material contains thermosetting resin and be in a B stage state or a C stage state.

Note that a material which provides an enhanced heat dissipation effect but generates gas with an increased temperature (for example, siloxane gas or the like), is not preferable in terms of durability.

There is a plurality of types of such a heat dissipation sheet, such as a paste type, a gel type, and a rubber type, but the paste type is preferably used in terms of being more excellent in flexibility and capable of covering the resin 6 in a more intimate contact state. Specific examples of the paste type include SARCON PG25A, SARCON PG80B, and SARCON PG130A (both manufactured by Fuji Polymer Industries Co., Ltd.).

The heat conductivity of the heat-transfer member 7 is preferably 20 W/mK or less, more preferably 2 W/mK or more and 20 W/mK or less, still more preferably 10 W/mK or more and 20 W/mK or less, in terms of excellence in balance between the heat dissipation effect and adhesiveness.

That is, the reason for the above is that although the higher heat conductivity is considered to enhance the heat dissipation effect, it is generally necessary to increase a content ratio of a metallic filler to enhance the heat conductivity of the heat-transfer member 7, and with the higher content ratio of the metallic filler, there is a tendency that the adhesiveness decreases.

In addition, the heat conductivity of the heat-transfer member 7 is preferably set within the above-mentioned ranges from a point that the heat dissipation effect can be enhanced by bringing the heat-transfer member 7 into contact with the resin 6.

Note that the heat conductivity is a value measured by a heat conductivity measurement method by a hot-disk method (in conformity with ISO/CD 22007-2).

The Asker C hardness of the heat-transfer member 7 is preferably 40 or less, more preferably 5 or more and 40 or less, still more preferably 8 or more and 40 or less, even more preferably 10 or more and 40 or less, and furthermore preferably 15 or more and 40 or less, in terms of compatibility of ease of processing, prevention of damage on the other members, and decrease of contact thermal resistance.

The Asker C hardness of the heat-transfer member 7 is preferably set to be lower than the Asker C hardness of the resin 6. With this setting, it is possible to bring the heat-transfer member 7 in sufficiently intimate contact with the resin 6 without causing damage on the resin 6 and infallibly protect the photoelectric conversion unit 5.

Among others, the Asker C hardness P of the heat-transfer member 7, the Asker C hardness Q of the resin 6, and the Asker C hardness R of the photoelectric conversion unit 5 are preferably in a relationship shown in the following Expression (1), because it is possible to enhance compatibility of the heat dissipation effect and the protection of the photoelectric conversion unit 5.

$$P < Q < R \qquad ( 1 )$$

In addition, the Asker C hardness of the heat-transfer member 7 is preferably set to be lower than the Asker C hardness of the photoelectric hybrid substrate 18. In a case where the Asker C hardness of the heat-transfer member 7 is set in this manner, the photoelectric hybrid substrate 18 becomes difficult to be deformed by a pressing force applied when the heat-transfer member 7 is attached, and the increase in light loss due to the deformation of the photoelectric hybrid substrate 18 can be prevented.

The heat-transfer member 7 may be formed of a single layer or a plurality of layers made of different materials. In a case where the heat-transfer member 7 is formed of the plurality of layers, it is preferable to use materials that decrease mutual contact thermal resistance so as to eliminate the need for pressing formation with a strong force. For example, the heat-transfer member 7 may be a multi-layered body in which a graphite sheet having high heat conductivity is provided on the first housing 3 side and the heat dissipation sheet is provided on the photoelectric hybrid substrate 18 side. Examples of the above-mentioned graphite sheet include a pyrolytic graphite sheet (PGS) graphite sheet (GraphiteTIM) manufactured by Panasonic Corporation.

In addition, the thickness of the heat-transfer member 7 (a distance s from the first surface 17a of the substrate 17 to the first housing 3) is preferably as small as possible in terms of shortening of the distance from the photoelectric conversion unit 5 to the first housing 3 and excellence in heat dissipation, as illustrated in FIG. 6.

However, since the heat-transfer member 7 being too thin brings the first housing 3 into contact with the photoelectric conversion unit 5 due to manufacturing tolerances of members and causes a manufacturing defect, the heat-transfer member 7 is preferably designed to have a thickness in consideration of the thickness of the photoelectric conversion unit 5 (a distance u from the first surface 17a of the substrate 17 to the highest location of the photoelectric conversion unit 5) and the thickness of the resin 6 that covers the photoelectric conversion unit 5 (a distance t from the first surface 17a of the substrate 17 to the highest location). Note that in a case where the photoelectric conversion unit 5 includes a plurality of members, assume that a distance to the highest member is the distance u.

Specifically, a ratio of the distance s to the distance t (s/t) is preferably at 1 or more and 20 or less, more preferably set at 1.1 or more and 10 or less, still more preferably set at 1.5 or more and 7 or less in terms of compatibility of the manufacturing tolerances and the heat dissipation effect. In addition, a ratio of the distance u to the distance t (u/t) is preferably at 0.2 or more and 1.2 or less, more preferably set at 0.4 or more and 1 or less, still more preferably set at 0.6 or more and 1 or less in terms of compatibility of the manufacturing tolerances and the heat dissipation effect.

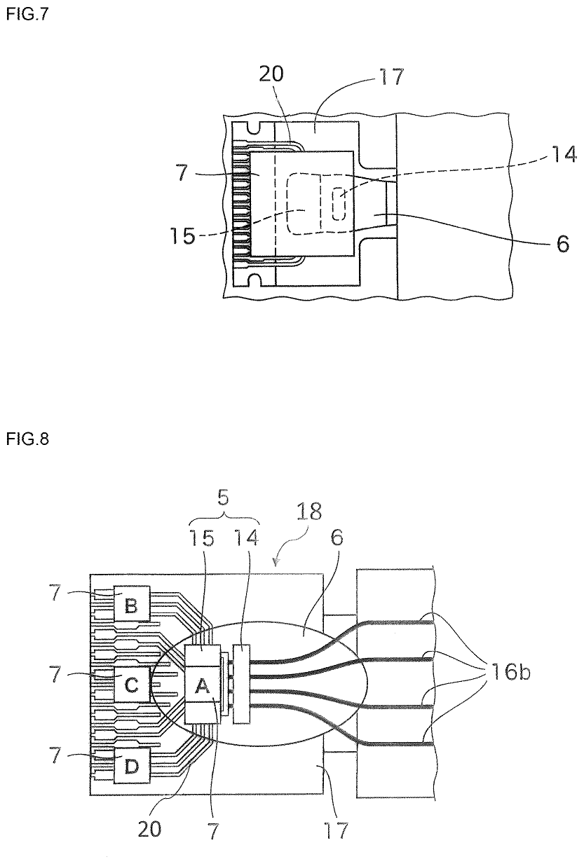

A size of the heat-transfer member 7 (meaning an area here) is only required to be smaller than that of the photoelectric hybrid substrate 18, and for example, may be such a size as that the heat-transfer member 7 is in contact with the whole of the surface 6a of the resin 6 facing the first housing 3 as illustrated in FIGS. 6 and 7, or may be such a size as that the heat-transfer member 7 is in contact with part of the surface 6a of the resin 6 facing the first housing 3 as illustrated in FIG. 4.

As illustrated in FIGS. 6 and 7, the heat-transfer member 7 in contact with the whole of the surface 6a of the resin 6 facing the first housing 3 not only exhibits the enhanced heat dissipation effect, but also protects the photoelectric conversion unit 5 more significantly. As illustrated in FIG. 4, the heat-transfer member 7 in contact with part of the surface 6a of the resin 6 facing the first housing 3 can implement the enhanced heat dissipation effect in a less amount of the heat-transfer member 7, and thus is more reduced in weight.

Note that in a case where the heat-transfer member 7 is in contact with part of the surface 6a of the resin 6 facing the first housing 3, it is preferable that the heat-transfer member 7 be installed at least on the integrated circuit (the drive IC 13 or the TIA 15) in terms of the heat dissipation effect.

The heat-transfer member 7 is only required to be in contact with the resin 6 and may be not in contact with the substrate 17. However, in a case where the heat-transfer member 7 is in contact with the substrate 17, a contact area of the heat-transfer member 7 with respect to the other members such as the resin 6 and the substrate 17 increases, and thus it is possible to increase the adhesiveness.

In addition, the heat-transfer member 7 is preferably installed in a portion where the edge of the PCB 22 does not damage the optical waveguide 16 in terms of protection of the photoelectric composite transmission module 1 according to the first aspect.

Furthermore, as illustrated in FIG. 8, the photoelectric hybrid substrate 18 further includes the wiring pattern 20 that transmits an electric signal from the photoelectric conversion unit 5 or transmits an electric signal to the photoelectric conversion unit 5.

In a case where the heat-transfer member 7 is also in contact with at least part of the wiring pattern 20 (for example, an area of 10% or more and 100% or less of an area of the wiring pattern), it is possible to protect a connection portion between the photoelectric conversion unit 5 and the wiring pattern 20 more significantly, and further increase the durability of the photoelectric composite transmission module 1 according to the first aspect.

### Other Members

In the present disclosure, another member may be further attached and used to further enhance the heat dissipation effect.

For example, a member made of metal (for example, a leaf spring or a spring) may be used in combination at a predetermined portion of the second surface 17b of the substrate 17.

In a case where the above-mentioned leaf spring is used, it is preferable to select the leaf spring made of a material having high heat conductivity (for example, C2680: 65% copper, 35% zinc, two types of brass, heat conductivity of 117 W/mk or the like). In a case where the above-mentioned spring is used, it is preferable to use a spring having a small roll diameter and a small spring height. Examples of the material of the spring include SUS304 (stainless-steel: heat conductivity of 15 W/mK).

However, since the present disclosure provides a sufficient heat dissipation effect, it is not necessary to attach such a member in terms of the reduction in thickness.

The photoelectric composite transmission module 1 according to the first aspect of the present disclosure can be manufactured, for example, in the following manner.

First, prepared is the photoelectric hybrid substrate 18 in which the optical waveguide 16 is formed on the second surface 17b of the substrate 17 on which predetermined wiring (wiring pattern 20 and the like) is formed. The light-emitting element 12, the drive IC 13 or the light-receiving element 14, and the TIA 15 of the photoelectric conversion unit 5 are then mounted on the photoelectric hybrid substrate 18. In addition, the resin 6 is applied so as to cover the light-receiving element 14 and the TIA 15 provided in the photoelectric conversion unit 5 to perform resin sealing. The PCB 22 is then connected to the photoelectric hybrid substrate 18 using the ZIF connector 10.

Subsequently, the heat-transfer member 7 is placed at a predetermined position inside the first housing 3. The first housing 3 is then attached to the photoelectric hybrid substrate 18 on the surface side on which the photoelectric conversion unit 5 is provided, whereby the surface 6a of the resin 6 facing the first housing 3 and the first housing 3 can be brought into contact with the heat-transfer member 7.

Thereafter, the second housing 4 is attached to the photoelectric hybrid substrate 18 on the surface side on which the optical waveguide 16 is provided, whereby the case 19 is formed by the first housing 3 and the second housing 4, and the photoelectric composite transmission module 1 according to the first aspect can be obtained.

### Optical Communication Cable

An optical communication cable is obtained by the connection of the hybrid cable 2 to the photoelectric composite transmission module 1 according to the first aspect of the present disclosure. As the hybrid cable 2, for example, it is possible to use, not only a plastic optical fiber, a glass optical fiber, or the like, but also an optical waveguide having a sheet like or a plate-like structure, a cable obtained by combining each of these components with a conductor cable of various kinds, or the like. Among them, the plastic optical fiber is preferably used in terms of flexibility.

According to the photoelectric composite transmission module 1 in the first aspect of the present disclosure, since the photoelectric conversion unit 5 is covered with the resin 6, and the resin 6 and the first housing 3 are in contact with the heat-transfer member 7, a sufficient heat dissipation effect can be obtained. Further, the configuration eliminates the need for providing the protrusion that protrudes to the inside of the first housing 3, and can thereby result in a reduction in thickness, size, and weight. In addition, the configuration causes no damage on the photoelectric conversion unit 5 due to a collision of the protrusion.

According to the optical communication cable of the present disclosure, since the photoelectric composite transmission module 1 according to the first aspect of the present disclosure is used as a photoelectric composite transmission module, the optical communication cable is reduced in thickness, size, and weight, implements the infallible protection of the photoelectric conversion unit 5, and is also excellent in durability.

### EXAMPLES

The present disclosure will be more specifically described below using Examples. However, the present disclosure is not limited to the following Examples without departing from the gist of the present disclosure.

### Example 1 and Comparative Examples 1 to 3

First, as the heat-transfer member 7, prepared was a heat-transfer member is a 1×1 mm cube in a thickness of 2 mm (corporate name: Fuji Polymer Industries Co., Ltd., part number: PG130A, material composition: silicone polymer, aluminum oxide, and aluminum nitride, heat conductivity: 13 W/mK, Asker C hardness: 22). In addition, as the first housing 3 and the second housing 4, members each made of 96% zinc and 4% aluminum were prepared.

Subsequently, the photoelectric hybrid substrate 18 was produced (including the optical waveguide 16 that was ten times harder than the heat-transfer member and an IC connected by using gold that was harder than the heat-transfer member) using epoxy resin as the resin 6 that covered the photoelectric conversion unit 5. The heat-transfer member 7 was attached to the first housing 3 so that the heat-transfer member 7 was changed in position to come in contact with the photoelectric hybrid substrate 18 on the Rx side at any one of positions A to D as illustrated in FIG. 8, and respective photoelectric composite transmission modules were produced.

That is, the photoelectric composite transmission module that was attached so as to come in contact with the resin 6 on the drive IC 13 (at the position A) served as the Example 1. The photoelectric composite transmission modules that were attached at the other positions (the positions B and D were on the first surface 17a of the substrate, and the position C was on a boundary between the first surface 17a of the substrate and the resin 6) served as Comparative Examples 1 to 3.

To make a comparison, a photoelectric composite transmission module (without a heat-transfer member) that was similar to Example 1 except that the heat-transfer member 7 was not attached thereto was produced.

With use of these photoelectric composite transmission modules, video images in conformity with the DisplayPort standard were transmitted from the Tx side (the light-emitting element 12: VCSEL) to the Rx side (the light-receiving element 14: PD), and image errors (the number of pixel errors) were respectively counted.

Specifically, as video images, 2000 frames of “4K video images (2160×3840)” were transmitted, and the lowest current value of the PD indicating zero image error (zero pixel error) was measured.

The respective values obtained from the photoelectric composite transmission modules were then substituted into the following Expression to calculate respective amounts of improvement (dB).

Amount of improvement (dB)=10×log 10 (the lowest current value of the PD in “comparison”)/the lowest current value of the PD in “Examples or Comparative Example”)

The respective positions of the heat-transfer members 7 used in Examples and Comparative Examples and the calculated amounts of improvement (dB) are indicated in the following Table 1.

TABLE 1

| | | Compar- | Compar- | Compar- | |
|---|---|---|---|---|---|
| | Exam- | ative | ative | ative | Com- |
| | ple 1 | example 1 | example 2 | example 3 | parison |
| Position | A | B | C | D | None |
| Amount of | 1.65 | 0.23 | 0.75 | 0.23 | — |
| improvement | | | | | |
| (dB) | | | | | |

As indicated by the above-mentioned results, it was found that the photoelectric composite transmission module according to Example 1 was significantly improved from the photoelectric composite transmission module without the heat-transfer member 7. In contrast, it was found that the photoelectric composite transmission modules according to Comparative Examples 1 to 3 were hardly improved despite use of the heat-transfer members 7 that were identical in size to that according to Example 1.

### Examples 2 to 5

First, as the heat-transfer member 7, prepared were heat-transfer members 7 obtained by adjusting the heat-transfer member 7 used in Example 1 into the following sizes E to H.

That is, E represents a 1 mm×1 mm cube (in a size that is approximately identical to the size of the drive IC 13 in a plan view), F represents a 3 mm×3 mm cube (in a size to cover also a portion of the photoelectric conversion unit 5), G represents a 5 mm×5 mm cube (in a size to cover also the resin 6), H represents a 7 mm×7 mm cube (in a size to cover the whole surface of the substrate 17).

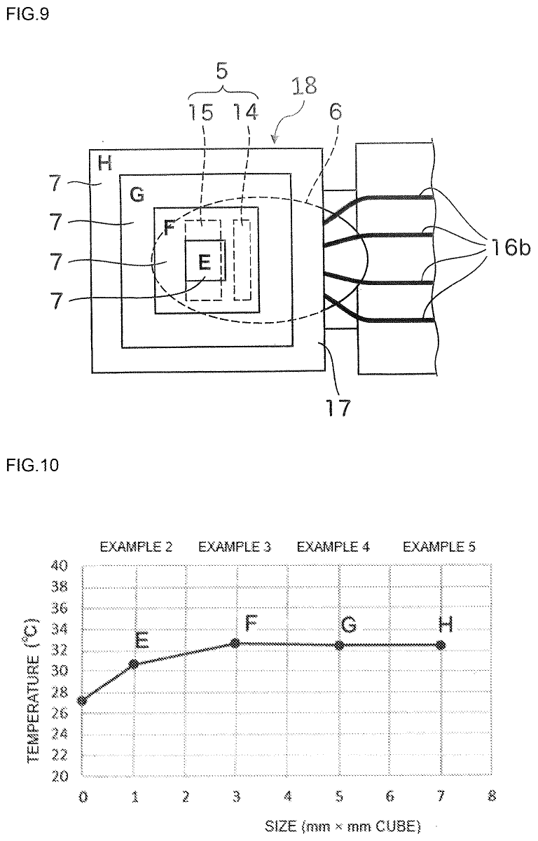

Then, as illustrated in FIG. 9, each heat-transfer member 7 was attached to the first housing 3 so as to come into contact with a corresponding portion at a position with a surface center being immediately above the drive IC 13. The respective photoelectric composite transmission modules were produced in a manner similar to Example 1 with respect to the other conditions.

Respective amounts of improvement (dB) were calculated with respect to the obtained photoelectric composite transmission modules in a manner similar to that in Example 1.

The sizes of the heat-transfer members 7 used in Examples and the calculated amounts of improvement (dB) are indicated in conjunction with Table 2 below.

TABLE 2

| | Example 2 | Example 3 | Example 4 | Example 5 |
|---|---|---|---|---|
| Size | E | F | G | H |
| Amount of | 1.65 | 2.00 | 2.00 | 2.00 |
| improvement (dB) | | | | |

As indicated by the above-mentioned results, it was found that the respective amounts of improvement of the photoelectric composite transmission modules according to the Example 2 to 5 were approximately identical regardless of the sizes of the heat-transfer members 7. Based on the above, it has been found that the position of the heat-transfer member 7 is more important than the size of the heat-transfer member 7, and specifically, it is important to bring the heat-transfer member 7 into contact with the portion immediately above the drive IC 13.

Furthermore, with respect to each of the photoelectric composite transmission modules in Examples 2 to 5, a thermocouple was attached to the external side of the first housing 3 (on the opposite side of one side of the first housing 3 in contact with the heat-transfer member 7), and a temperature of the first housing 3 at the time of transmission of the above-mentioned video images was measured at an ambient temperature of 25° C. Measurement results are indicated together in FIG. 10.

As indicated by the results in FIG. 10, the respective temperatures of the first housings 3 in the photoelectric composite transmission modules according to Example 2 to 5 were approximately identical. Based on this, it has been found that bringing the heat-transfer member 7 into contact with the portion immediately above the drive IC 13 is more important than the size of the heat-transfer member 7.

Additionally, based on the results of Examples 1 and 2, it has been found that the heat-transfer member 7 that is approximately identical in size to the drive IC 13 is brought into contact with at least the resin 6 immediately above the drive IC 13 and the first housing 3, whereby a sufficient heat dissipation effect can be exerted.

Therefore, to further reduce weight, it is preferable to use the heat-transfer member 7 that is approximately identical in size to the drive IC 13. To further increase durability, it is preferable to use the heat-transfer member 7 having such a size as to come in contact with the whole surface of the resin 6 including the portion facing the drive IC 13.

### Second Aspect

Various kinds of housing structures of the photoelectric composite transmission module have been proposed. For example, PTL 2 has proposed a photoelectric composite transmission module in which the upper and lower vicinities of a light-emitting element are formed to be flat, and that has a box-like housing structure as a whole.

On the other hand, in terms of the reduction in size of the photoelectric composite transmission module, also proposed is a photoelectric composite transmission module in which an external thickness of a housing is changed depending on a location so as to increase the external thickness of the housing at a location where the number of components to be housed inside is large and decrease the external thickness of the housing at a location where the number of components to be housed inside is small.
[PTL 2] JP2015-22129A

However, with this configuration, since an internal space becomes narrow in a location with a small thickness, an installation position of each member is inevitably restricted. However, since an internal space becomes wide in a location with a large thickness, the installation position of each member can be freely determined to some extent. Hence, in the location with the large thickness, it is generally required to adjust and more strictly determine the positions of various kinds of members (the position of the heat dissipation member, the position of the PMT connector, and the like) so that respective functions can be sufficiently exerted.

Additionally, in the photoelectric composite transmission module in which the thickness of the housing is changed depending on a location, since a member such as a cable is provided in the location with the large thickness, the substrate including the light-emitting element is provided at a position straddling the location with the small thickness and the location with the large thickness. Therefore, there is a problem that it is difficult to provide a member at an accurate position as designed in the vicinity of the light-emitting element or the like.

### PROBLEMS TO BE SOLVED BY THE DISCLOSURE

In view of the above, an aspect of the present disclosure is to provide a photoelectric composite transmission module that is reduced in size, in which a member is provided at an accurate position as designed even in the vicinity of a light-emitting element or the like, and that is excellent in a heat dissipation effect and design, and an optical communication cable using the photoelectric composite transmission module.

### Means for Solving the Problems

The inventors have found, as a result of intensive research, that when a photoelectric conversion unit covered with resin, a frame wall serving as an installation guide for a heat-transfer member provided on the internal surface of a housing, and the heat-transfer member is installed in a region surrounded by the frame wall, whereby a surface of the resin facing the housing can be brought into contact with the housing via the heat-transfer member at a desired position, so that even in the photoelectric composite transmission module that is reduced in size, the heat-transfer member can be provided at an accurate position as designed.

### EFFECTS OF THE DISCLOSURE

According to embodiments of the present disclosure, since the installation guide is provided in the housing and the attachment position of the heat-transfer member is clearly defined, it is possible to implement an operation of attaching the heat-transfer member with efficiency. In addition, since the installation of the heat-transfer member in the region surrounded by the installation guide can infallibly prevent the heat-transfer member from protruding, it is possible to prevent occurrence of a malfunction such as application of stress to an edge of the PCB by the protruded heat-transfer member.

Furthermore, since it is possible to efficiently dissipate heat from the photoelectric conversion unit, the present disclosure enables a reduction in thickness, size, and weight, and also enables excellent design.

### EMBODIMENTS OF THE DISCLOSURE

A second aspect of the present disclosure will be described below.

However, the present disclosure is not limited to the following embodiment.

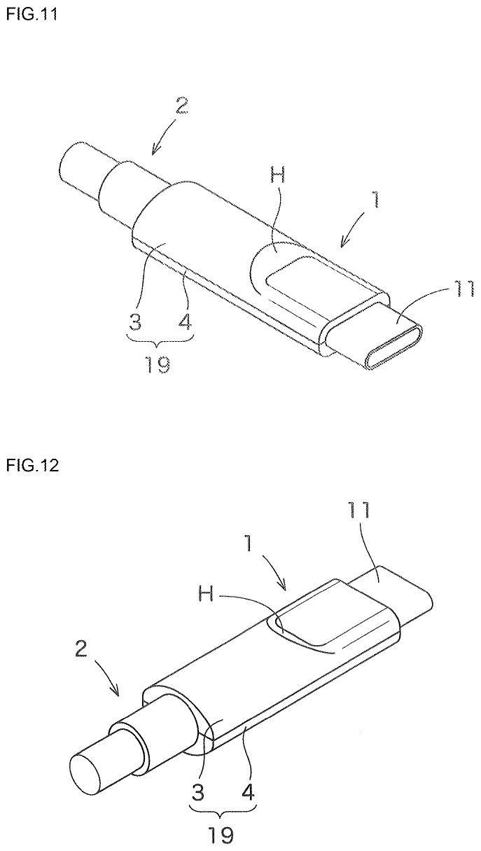

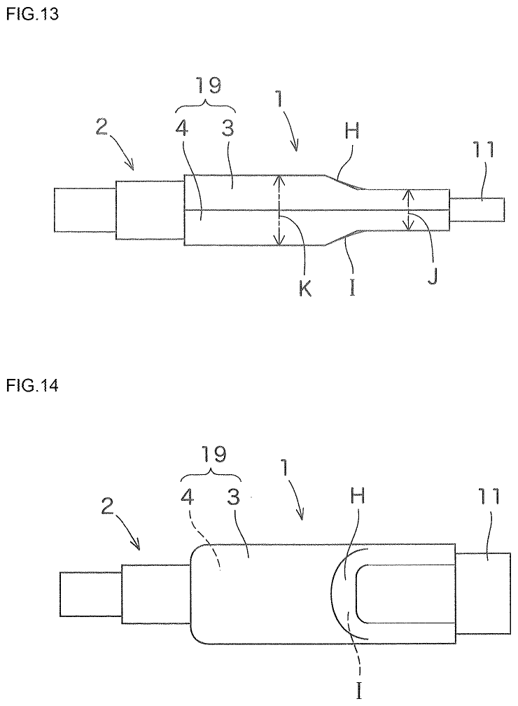

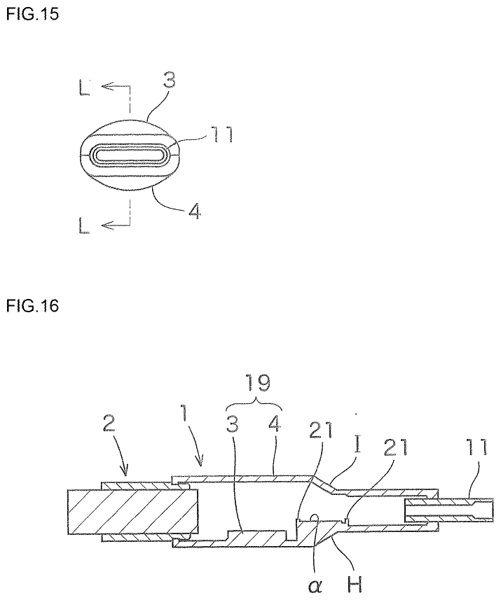

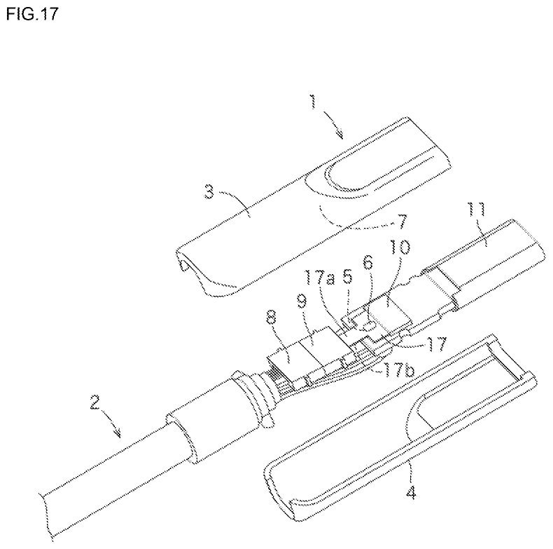

FIGS. 11 and 12 are perspective views each illustrating an outer appearance of a photoelectric composite transmission module 1 according to the second aspect as one of the embodiments of the present disclosure. In addition, FIG. 13 is a front view illustrating the outer appearance of the photoelectric composite transmission module 1 according to the second aspect when viewed from the front side. FIG. 14 is a plan view illustrating the outer appearance of the photoelectric composite transmission module 1 according to the second aspect when viewed from the above. In addition, FIG. 15 is a right-side view illustrating the outer appearance of the photoelectric composite transmission module 1 according to the second aspect when viewed from the right side. FIG. 16 is a cross-sectional view along L-L in which part of an internal structure of the photoelectric composite transmission module 1 according to the second aspect illustrated in FIG. 15 is omitted. Furthermore, FIG. 17 is an exploded perspective view illustrating a configuration of the photoelectric composite transmission module.

The photoelectric composite transmission module 1 according to the second aspect of the present disclosure converts light output from a hybrid cable 2 into electricity, inputs the electricity to an electrical device (not illustrated), converts electricity output from the electrical device (not illustrated) into light, and inputs the light to the hybrid cable 2. Note that FIG. 17 illustrates an MT optical connector 8, a PMT optical connector 9, a ZIF connector 10, and a plug 11. Examples of the plug mentioned herein include a type-C plug and a HDMI (registered trademark) plug.

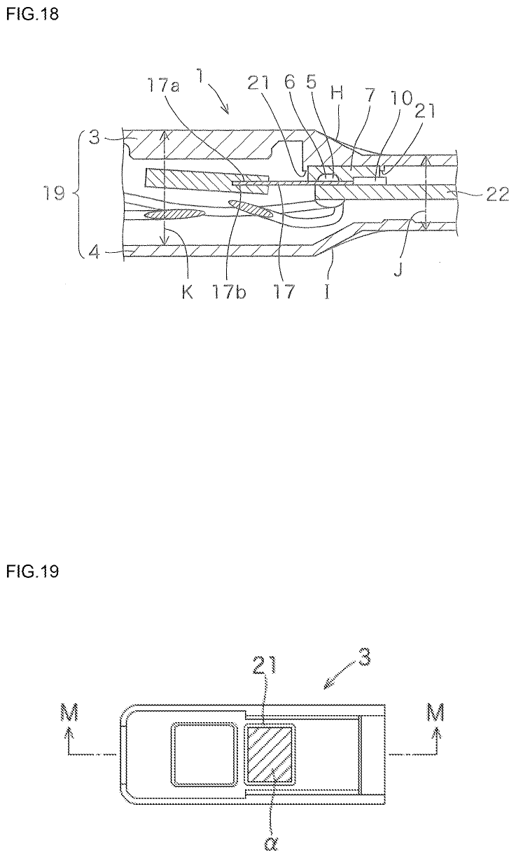

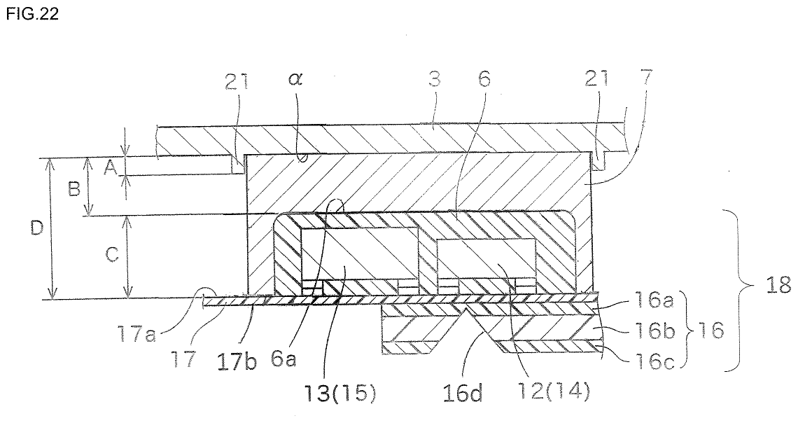

The photoelectric composite transmission module 1 according to the second aspect of the present disclosure includes: a photoelectric hybrid substrate 18 including a photoelectric conversion unit 5 and an optical waveguide 16 (refer to FIG. 22); the ZIF connector 10 that connects the photoelectric hybrid substrate 18 and a printed circuit board (PCB) 22; a first housing 3; a second housing 4; and a heat-transfer member 7, as illustrated in FIG. 18. The heat-transfer member 7 is provided between the surface of the photoelectric hybrid substrate 18 on which the photoelectric conversion unit 5 is provided and the first housing 3.

In addition, the photoelectric conversion unit 5 is covered with resin 6, and a surface 6a of the resin 6 facing the first housing 3 and the first housing 3 are in contact with the heat-transfer member 7 (refer to FIG. 22).

At this time, a frame wall 21 that serves as the installation guide for the heat-transfer member 7 is provided on the internal surface of the first housing 3, and the heat-transfer member 7 is installed in a region a surrounded by the frame wall 21 (a hatched portion in FIG. 19).

Details of these components will be described below.

### Photoelectric Hybrid Substrate

The photoelectric hybrid substrate 18 includes a substrate 17, the photoelectric conversion unit 5 provided on a first surface 17a of the substrate 17, and the optical waveguide 16 provided on a second surface 17b of the substrate 17, as illustrated in FIG. 22.

The photoelectric conversion unit 5 and a wiring pattern and the like connected to the photoelectric conversion unit 5 are provided on the first surface 17a of the substrate 17.

The substrate 17 is, for example, a flexible printed circuit (FPC). Examples of the substrate include a substrate obtained by hardening glass fabrics or glass non-woven fabrics with epoxy resin (for example, CEM-3 or the like), a substrate obtained by hardening glass fabrics with epoxy resin (for example, FR-4, FR-5, or the like), metal, PTFE, polyimide, or the like. The thickness of the substrate is, for example, 20 μm or more and 200 μm or less.

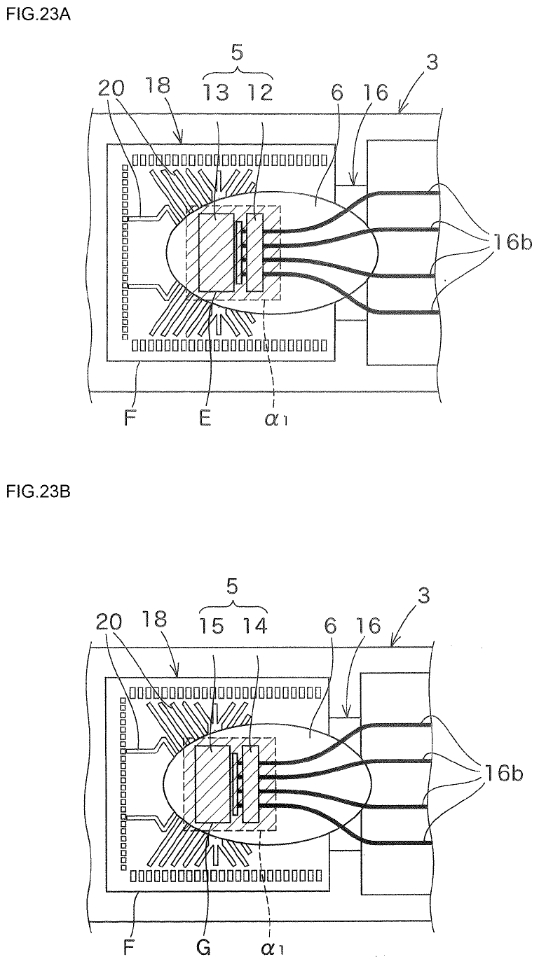

The photoelectric conversion unit 5 including a plurality of members that converts light into electricity or converts electricity into light is provided on the first surface 17a of the substrate 17. On a light-receiving side (Rx: refer to FIG. 23B), for example, a light-receiving element 14 and a TIA 15 are provided as the photoelectric conversion unit 5 and connected to each other by the wiring pattern. On a light-emitting side (Tx: refer to FIG. 23A), for example, a light-emitting element 12 and a drive IC 13 are provided as the photoelectric conversion unit 5 and connected to each other by the wiring pattern.

The light-emitting element 12 converts electricity into light. Specific examples of the light-emitting element 12 include a surface emitting diode (VCSEL). The drive IC 13 electrically connected to the light-emitting element 12 is installed in the vicinity of the light-emitting element 12.

The light-receiving element 14 converts light into electricity. Specific examples of the light-receiving element 14 include a PD. The TIA 15 electrically connected to the light-receiving element 14 is installed in the vicinity of the light-receiving element 14.

In the photoelectric conversion unit 5, on the light-emitting side (Tx), the light-emitting element 12 converts electricity input from the wiring pattern to the drive IC 13 into light and emits this optical signal toward a mirror 16d in the optical waveguide 16.

On the light-receiving side (Rx), the light-receiving element 14 electrically converts light input from the mirror 16d in the optical waveguide 16 to the light-receiving element 14 into electricity, and the TIA 15 amplifies the electricity and outputs the amplified electricity toward the wiring pattern.

In this manner, the photoelectric conversion unit 5 is capable of performing conversion between electricity and light.

The photoelectric conversion unit 5 includes an electrode (not illustrated), and is mounted on the substrate 17 so as to be electrically connected to a terminal (not illustrated) of the substrate 17 via a bump (not illustrated).

The optical waveguide 16 is provided on the second surface 17b of the substrate 17.

The optical waveguide 16 has a substantially sheet-like shape that extends in a longitudinal direction, and includes an under-cladding layer 16a, a core layer 16b, and an over-cladding layer 16c. The mirror 16d is formed at an end of the core layer 16b in a longitudinal direction. Examples of a material of the optical waveguide 16 include a transparent material such as epoxy resin. The thickness of the optical waveguide 16 is set, for example, between 20 μm or more and 200 μm or less.

The thickness of the photoelectric hybrid substrate 18 including these components is, typically, 25 μm or more and 500 μm or less, and is preferably 40 μm or more and 250 μm or less in terms of excellence in balance between the reduction in thickness and ease of handling.

### Resin

The photoelectric conversion unit 5 provided on the first surface 17a of the substrate 17 is covered with the resin 6.

The thickness of the resin 6 is not specifically limited, but is preferably 100 μm or more and 500 μm or less, more preferably 150 μm or more and 300 μm or less, in terms of infallible protection of the photoelectric conversion unit 5 and the reduction in thickness of the photoelectric composite transmission module 1 according to the second aspect.

Note that the thickness of the resin 6 is assumed to be a distance from the first surface 17a of the substrate 17 to the highest location of the resin 6 (typically, the surface 6a facing the first housing 3), as indicated by a reference sign C in FIG. 22.

As the material of the resin 6, for example, a material having heat conductivity (W/mK) of 0.1 W/mK or more and 3 W/mK or less, more preferably 0.1 W/mK or more and 1 W/mK or less, in terms of excellence in balance between a heat dissipation effect, adhesiveness, heat resistance, and light transmissivity. Examples of such a material include epoxy resin and acrylic resin, and especially, the epoxy resin is preferably used in terms of excellence especially in combination with the heat-transfer member 7.

### First Housing and Second Housing

The first housing 3 that protects a surface side of the photoelectric hybrid substrate 18 on which the photoelectric conversion unit 5 is provided can constitute, in combination with the second housing 4 that pairs up with the first housing 3, a case 19 that has a substantially box shape and that houses the photoelectric hybrid substrate 18 (refer to FIG. 11).

In the present disclosure, as the shape of the case 19, a facing distance between the first housing 3 and the second housing 4 is preferably designed so that one end side is shorter than the other end side. Specifically, as indicated by a dash-dotted line in FIG. 13, a facing distance J on the one end side is preferably designed to be shorter than a facing distance K on the other end side. In other words, an external thickness of a housing formed of the first housing and the second housing is preferably designed to be different between the one end side and the other end side. Note that the facing distance J and the facing distance K each represent a distance between the farthest locations (typically, the surfaces of the case 19).

Hence, a first displacement portion H to change the facing distance is preferably provided in the first housing 3. In addition, a second displacement portion I to change the facing distance is preferably provided in the second housing 4, and is preferably provided at a position facing the first displacement portion H provided in the first housing 3 in terms of excellence in design. Here, the displacement mentioned in the specification means, for example, a level difference.

The first housing 3 and the second housing 4 (hereinafter may be referred to as “the first housing 3 or the like”) are preferably made of a material having as high heat conductivity as possible in consideration of the heat dissipation effect, especially, a material having heat conductivity of 50 W/mK or more.

The first housing 3 and the second housing 4 are more preferably made of metal in terms of high heat conductivity, high strength, and compatibility of the heat dissipation effect and protection of the inside (the photoelectric conversion unit 5 and the like). Specific examples of the metal material include aluminum, copper, silver, zinc, nickel, chrome, titanium, tantalum, platinum, gold, and an alloy thereof (red brass, stainless-steel, and the like). Each of these materials can be used alone or two or more types thereof can be used in combination. In terms of surface protection and aesthetic merit, the first housing 3 or the like may be subjected to surface processing such as plate processing.

As the thickness of the first housing 3 or the like increases, the heat dissipation effect increases, but the weight also increases. Thus, the thickness of the first housing 3 or the like is preferably 0.1 mm or more and 0.6 mm or less, more preferably 0.2 mm or more and 0.5 or less in consideration of balance between the heat dissipation effect and the reduction in weight.

Note that it can also be considered that the increase in thickness of the first housing 3 does not enhance the heat dissipation effect because heat dissipates sufficiently in the longitudinal direction. However, since the area in contact with an external space increases, it can be considered that the heat dissipation effect is enhanced natural-logarithmically.

In addition, the frame wall 21 that serves as an installation guide for the heat-transfer member 7 is provided on the internal surface of the first housing 3, as illustrated in FIG. 19. That is, the frame wall 21 is provided to install the heat-transfer member 7 at an accurate position at the time of installation of the heat-transfer member 7, and is formed so as to surround a position at which the heat-transfer member 7 is to be installed. The heat-transfer member 7 is installed in a region a surrounded by the frame wall 21.

In the present disclosure, in a case where the whole circumference of the heat-transfer member 7 is surrounded by the frame wall 21 as illustrated in FIG. 19, the region a surrounded by the frame wall 21 means a surrounded region.

However, the frame wall 21 is only required to function as the installation guide for the heat-transfer member 7, and does not necessarily surround the whole circumference of the heat-transfer member 7. Thus, in the present disclosure, the region a is meant to further include a region surrounded by a virtual line r supplemented by extending from the frame wall 21 in a circumferential direction, as illustrated in FIG. 21A and FIG. 21B.

The region a is preferably set at a location where the region a is in contact with the ZIF connector 10 via another member when the first housing 3 is attached to the photoelectric hybrid substrate 18 (refer to FIG. 18). With this setting, the heat-transfer member 7 can be attached to the first housing 3 in such arrangement as that the heat-transfer member 7 overlaps with the ZIF connector 10.

The region a is preferably provided to include a portion facing the photoelectric conversion unit 5 when the photoelectric hybrid substrate 18 is attached to the first housing 3. It is especially preferable that the region a is provided to include a portion facing the drive IC 13 and/or the TIA 15. With this setting, the heat-transfer member 7 can be infallibly attached to the first housing 3 in such arrangement as that the heat-transfer member 7 overlaps with the drive IC 13 and/or the TIA 15, and the heat dissipation can be performed efficiently.

An area α₁ of the region a is preferably 95% or more, more preferably 110% or more of an area E when viewed vertically above the drive IC 13 in the photoelectric conversion unit 5 from a point that the heat dissipation can be performed efficiently with a less use amount of the heat-transfer member 7 (refer to FIG. 23A).

Further, for a similar reason, the area di of the region a is preferably 95% or more, more preferably 110% or more of an area G when viewed from vertically above the TIA 15 in the photoelectric conversion unit 5 (refer to FIG. 23B).

Furthermore, the area α₁ of the region a is preferably 110% or less, more preferably 90% or less of an area F when viewed from vertically above the photoelectric hybrid substrate 18. With such a setting of the area of the region a, not only the enhanced heat dissipation effect is obtained, but also the photoelectric conversion unit 5 and its surrounding members can be protected more significantly (refer to FIG. 23A and FIG. 23B).

Note that FIG. 23A and FIG. 23B each give illustration so that the first housing 3 is transparent and part of a wiring pattern 20 and the like is omitted for easier understanding of a positional relationship between the region α and the drive IC 13 (or the TIA 15) in a case where the first housing 3 is attached to the photoelectric hybrid substrate 18.

In addition, a height A of the frame wall 21 (refer to FIG. 22) is preferably 150 μm or more and 450 μm or less, more preferably 210 μm or more and 390 μm or less from a point that the heat-transfer member 7 can be infallibly prevented from protruding from a location at which the heat-transfer member 7 is to be installed when installed.

Note that the height A of the frame wall 21 is assumed to be a distance from the internal surface of the first housing 3 in the region α to the highest location of the frame wall 21.

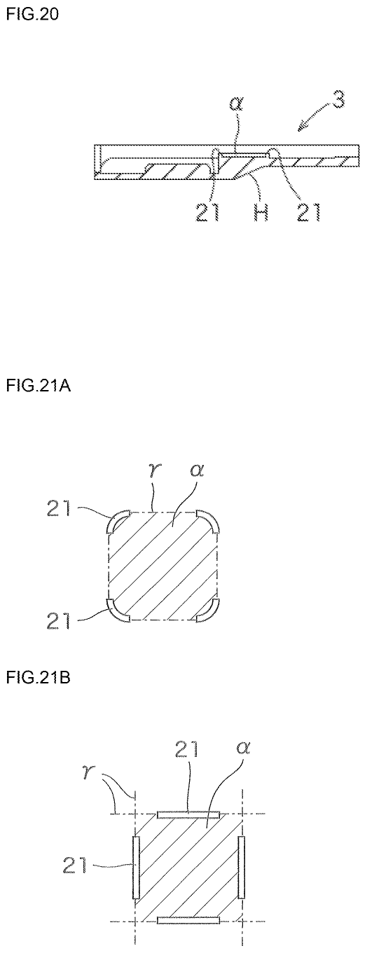

The frame wall 21 is preferably provided in the first displacement portion H (refer to FIG. 20). That is, the reason for the above is that, since the heat-transfer member 7 installed in the region α surrounded by the frame wall 21 is provided in the vicinity of the photoelectric conversion unit 5 as described later, the provision of the frame wall 21 in the first displacement portion H allows the heat-transfer member 7 to be provided in the first displacement portion H.

In the present disclosure, a protrusion with a height of 4 mm or more is not provided inside the first housing 3. That is, the inside of the first housing 3 is formed as a flat surface, and the frame wall 21 is provided on the flat surface.

This configuration can save the internal space of the case 19 formed by a combination of the first housing 3 and the second housing 4 by the absence of the protrusion, and can implement the reduction in thickness, size, and weight of the photoelectric composite transmission module 1 according to the second aspect.

In addition, since the distance from the photoelectric conversion unit 5 to the first housing 3 can be shortened by the absence of the protrusion, it is possible to further enhance the heat dissipation effect.

Furthermore, since the protrusion that protrudes toward the internal surface is not formed, the photoelectric conversion unit 5 is not damaged by the protrusion when the first housing 3 or the like is attached to the photoelectric hybrid substrate 18, when the photoelectric conversion unit 5 is subjected to shock from the outside, or other cases.

### Heat-Transfer Member

As the heat-transfer member 7 provided between the surface of the photoelectric hybrid substrate 18 on which the photoelectric conversion unit 5 is provided and the first housing 3, a heat-transfer member that is expected to provide the heat dissipation effect can be used.

That is, the reason for the above is that with the enhanced heat dissipation effect, it is possible to further reduce thermal noise from the drive IC 13 and the TIA 15 and further increase the output of the light-emitting element such as a VCSEL and the light-receiving element.

As such a heat-transfer member 7, for example, a heat dissipation sheet, a heat dissipation grease, a heat dissipation plate, or the like can be used.

Examples of the heat dissipation sheet include a filler resin composition in which a filler such as alumina (aluminum oxide), boron nitride, zinc oxide, aluminum hydroxide, molten silica, magnesium oxide, and aluminum nitride is dispersed into base resin such as silicone resin, epoxy resin, acrylic resin, and urethane resin. Each of these materials can be used alone or two or more types thereof can be used in combination.

Among these materials, a material that uses silicone resin is preferably used as the base resin in terms of excellence in balance among an insulation property, adhesiveness, and heat conductivity.

The heat dissipation sheet is preferably made of a material having excellent flexibility from a point that it can be in more intimate contact with the surface 6a of the resin 6 facing the first housing 3 and the first housing 3. For a similar reason, it is preferable that the material preferably contain thermosetting resin and be in a B stage state or a C stage state.

Note that a material, which provides an enhanced heat dissipation effect but generates gas with an increased temperature (for example, siloxane gas or the like), is not preferable in terms of durability.

There is a plurality of types of such a heat dissipation sheet, such as a paste type, a gel type, and a rubber type, but the paste type is preferably used in terms of being more excellent in flexibility and capable of covering the resin 6 in a more intimate contact state. Specific examples of the paste type include SARCON PG25A, SARCON PG80B, and SARCON PG130A (manufactured by Fuji Polymer Industries Co., Ltd.).

The heat conductivity of the heat-transfer member 7 is preferably 20 W/mK or less, more preferably 2 W/mK or more and 20 W/mK or less, still more preferably 10 W/mK or more and 20 W/mK or less, in terms of excellence in balance between the heat dissipation effect and adhesiveness.

That is, the reason for the above is that although the higher heat conductivity is considered to enhance the heat dissipation effect, it is generally necessary to increase a content ratio of a metallic filler to enhance the heat conductivity of the heat-transfer member 7, and with the higher content ratio of the metallic filler, there is a tendency that the adhesiveness decreases.

In addition, the heat conductivity of the heat-transfer member 7 is preferably set within the above-mentioned ranges from a point that the heat dissipation effect can be enhanced by bringing the heat-transfer member 7 into contact with the resin 6.

Note that the heat conductivity is a value measured by a heat conductivity measurement method by a hot-disk method (in conformity with ISO/CD 22007-2).

The Asker C hardness of the heat-transfer member 7 is preferably 40 or less, more preferably 5 or more and 40 or less, still more preferably 8 or more and 40 or less, even more preferably 10 or more and 40 or less, and furthermore preferably 15 or more and 40 or less, in terms of compatibility of ease of processing, prevention of damage on the other members, and decrease of contact thermal resistance.

The Asker C hardness of the heat-transfer member 7 is preferably set to be lower than the Asker C hardness of the resin 6. With this setting, it is possible to bring the heat-transfer member 7 in sufficiently intimate contact with the resin 6 without causing damage on the resin 6 and infallibly protect the photoelectric conversion unit 5.

In addition, the Asker C hardness of the heat-transfer member 7 is preferably set to be lower than the Asker C hardness of the photoelectric hybrid substrate 18. For example, the photoelectric hybrid substrate 18 is about ten times as hard as the heat-transfer member 7. In a case where the Asker C hardness of the heat-transfer member 7 is set in this manner, the photoelectric hybrid substrate 18 becomes difficult to be deformed by a pressing force applied when the heat-transfer member 7 is attached, and the increase in light loss due to the deformation of the photoelectric hybrid substrate 18 can be prevented.

The heat-transfer member 7 may be formed of a single layer or a plurality of layers made of different materials. In a case where the heat-transfer member 7 is formed of the plurality of layers, it is preferable to use materials that decrease mutual contact thermal resistance so as to eliminate the need for pressing formation with a strong force. For example, the heat-transfer member 7 may be a multi-layered body in which a graphite sheet having high heat conductivity is provided on the first housing 3 side and the heat dissipation sheet is provided on the photoelectric hybrid substrate 18 side. Examples of the above-mentioned graphite sheet include a pyrolytic graphite sheet (PGS) graphite sheet (GraphiteTIM) manufactured by Panasonic Corporation.

In addition, as illustrated in FIG. 22, the thickness of the heat-transfer member 7 (a distance B from the internal surface of the first housing 3 in a region α to the surface 6a of the resin 6 facing the first housing 3) is preferably as small as possible in terms of shortening of the distance from the photoelectric conversion unit 5 to the first housing 3 and excellence in heat dissipation.

However, since the heat-transfer member 7 being too thin brings the first housing 3 into contact with the photoelectric conversion unit 5 due to manufacturing tolerances of members and causes a manufacturing defect, the heat-transfer member 7 is preferably designed to have a thickness in consideration of the thickness of the photoelectric conversion unit 5 and the thickness of the resin 6 that covers the photoelectric conversion unit 5.

Note that in a case where the photoelectric conversion unit 5 includes a plurality of members, assume that a distance to the highest member is a target of consideration.

The size of the heat-transfer member 7 (meaning an area here) is only required to be a size that allows the heat-transfer member 7 to be housed inside the frame wall 21 and not specifically limited, but is preferably such a size as that the heat-transfer member 7 is in contact with the inner wall of the frame wall 21.

In addition, as illustrated in FIG. 22, the height A of the frame wall 21 of the first housing 3 and the distance B from the internal surface of the first housing 3 in the region α surrounded by the frame wall 21 to the surface 6a of the resin 6 facing the first housing 3 are preferably designed to satisfy the following Expression (4). Especially, a ratio of the height A to the distance B (A/B) is more preferably 0.2 or more and 0.7 or less, still more preferably 0.3 or more and 0.6 or less.

$$0.2 \leq ( A / B ) \leq 0.7 \qquad ( 4 )$$

With the above-mentioned setting of the height A and the distance B, there is a tendency to exhibit excellence in maintaining a small thickness of the housing and fixing of the heat-dissipation member appropriately.

In addition, the distance B from the internal surface of the first housing 3 in the region α surrounded by the frame wall 21 on the internal surface of the first housing 3 to the surface 6a of the resin 6 facing the first housing 3 and a distance C from the substrate 17 (first surface 17a) to the surface 6a of the resin 6 facing the first housing 3 are preferably designed to satisfy the following Expression (3). Especially, a ratio of the distance B to the distance C (B/C) is preferably 2 or more and 3 or less, more preferably 2.2 or more and 2.8 or less.

$$2 \leq ( B / C ) \leq 3 \qquad ( 3 )$$

With the above-mentioned setting of the distance B and the distance C, there is a tendency to exhibit excellence in maintaining a small thickness of the housing and fixing of the heat-dissipation member appropriately.

In addition, the heat-transfer member 7 is preferably installed at a location in contact with the ZIF connector 10 (refer to FIG. 18). With this installation, since a lock of the ZIF connector 10 is maintained in a state of being pressed down from the above by the heat-transfer member 7, the lock of the ZIF connector 10 is prevented from being unintentionally unlocked, and the connection between the photoelectric hybrid substrate 18 and the PCB 22 can be prevented from being easily disconnected due to shock from the outside.

In addition, the heat-transfer member 7 is preferably installed at a location in contact with the drive IC 13 and/or the TIA 15 via the resin 6. With this installation, since it is possible to efficiently dissipate heat emitted from the drive IC 13 and/or the TIA 15, it is possible to obtain a sufficient heat dissipation effect as designed.

The heat-transfer member 7 is only required to be in contact with the resin 6, and may be not in contact with the substrate 17. However, in a case where the heat-transfer member 7 is in contact with the substrate 17, a contact area of the heat-transfer member 7 with respect to the other members such as the resin 6 and the substrate 17 increases, whereby it is possible to further increase adhesiveness.

In addition, the heat-transfer member 7 is preferably installed in a portion where the edge of the substrate 17 does not damage the optical waveguide 16 in terms of protection of the photoelectric composite transmission module 1 according to the second aspect.

In addition, the distance D from the internal surface of the first housing 3 in the region α surrounded by the frame wall 21 to the substrate 17 (the first surface 17a) is preferably 0.5 mm or more and 1.5 mm or less, more preferably 0.8 mm or more and 1.2 mm or less in terms of the reduction in thickness of the housing.

The height A of the frame wall in the first housing 3 and the distance D from the internal surface of the first housing 3 in the region α surrounded by the frame wall 21 to the substrate 17 are preferably designed to satisfy the following Expression (2). Especially, a ratio of the height A to the distance D (A/D) is preferably 0.1 or more and 0.5 or less, more preferably 0.2 or more and 0.3 or less.

$$0.1 \leq ( A / D ) \leq 0.5 \qquad ( 2 )$$

With the above-mentioned setting of the height A and the distance D, there is a tendency to exhibit excellence in maintaining a small thickness of the housing and fixing of the heat-dissipation member appropriately.

### Other Members

In the present disclosure, other member(s) may be further attached and used to further enhance the heat dissipation effect.

For example, a member made of metal (for example, a leaf spring or a spring) may be used in combination at a predetermined portion of the second surface 17b of the substrate 17.

In a case where the above-mentioned leaf spring is used, it is preferable to select the leaf spring made of a material having high heat conductivity (for example, C2680: 65% copper, 35% zinc, two types of brass, heat conductivity of 117 W/mk or the like). In a case where the above-mentioned spring is used, it is preferable to use a spring having a small roll diameter and a small spring height. Examples of a material of the spring include SUS304 (stainless-steel: heat conductivity of 15 W/mK).

However, since the present disclosure provides a sufficient heat dissipation effect, it is not necessary to attach such a member in terms of the reduction in thickness.

The photoelectric composite transmission module 1 according to the second aspect of the present disclosure can be manufactured, for example, in the following manner.

First, prepared is the photoelectric hybrid substrate 18 in which the optical waveguide 16 is formed on the second surface 17b of the substrate 17 on which predetermined wiring (wiring pattern 20 and the like) is formed. The light-emitting element 12, the drive IC 13 or the light-receiving element 14, and the TIA 15 as the photoelectric conversion unit 5 are then mounted on the photoelectric hybrid substrate 18. In addition, after the photoelectric conversion unit 5 is mounted, the resin 6 is applied so as to cover the photoelectric conversion unit 5 to perform resin sealing on the photoelectric conversion unit 5.

Subsequently, the heat-transfer member 7 is placed in the region α surrounded by the frame wall 21 inside the first housing 3. The first housing 3 is then attached to the photoelectric hybrid substrate 18 on the surface side on which the photoelectric conversion unit 5 is provided, whereby the surface 6a of the resin 6 facing the first housing 3 and the first housing 3 can be brought into contact with the heat-transfer member 7.

Thereafter, the second housing 4 is attached to the photoelectric hybrid substrate 18 on the surface side on which the optical waveguide 16 is provided, whereby the case 19 is formed by the first housing 3 and the second housing 4, and the photoelectric composite transmission module 1 according to the second aspect can be obtained.

According to the photoelectric composite transmission module 1 in the second aspect of the present disclosure, since a location at which the frame wall 21 to be installed (region a) is clearly defined when the heat-transfer member 7 is attached to the first housing 3, it is possible to implement an attachment operation with efficiency and accuracy. In addition, since the frame wall 21 prevents the heat-transfer member 7 from protruding, there occurs no malfunction such as application of stress to the edge of the substrate 17 by the protruded heat-transfer member 7.

In addition, since the first displacement portion H to change a facing distance is provided in the first housing 3, and the second displacement portion I to change a facing distance is provided in the second housing 4 at the position facing the first displacement portion H provided in the first housing, the reduction in weight is implemented and excellence in outer appearance is exhibited.

Furthermore, since the photoelectric conversion unit 5 is covered with the resin 6, and the resin 6 and the first housing 3 are in contact with the heat-transfer member 7, a sufficient heat dissipation effect can be obtained.

In addition, since the sufficient heat dissipation effect can be obtained, the configuration eliminates the need for providing the protrusion that protrudes to the inside of the first housing 3, and can thereby implement the reduction in thickness, size, and weight. It is also possible to eliminate the occurrence of damage on the photoelectric conversion unit 5 due to a collision of the protrusion.

### Optical Communication Cable

An optical communication cable is obtained by the connection of the hybrid cable 2 to the photoelectric composite transmission module 1 according to the second aspect of the present disclosure e. As the hybrid cable 2, for example, it is possible to use, not only a plastic optical fiber, a glass optical fiber, or the like, but also an optical waveguide having a sheet like or a plate-like structure, a cable obtained by combining each of these components with a conductor cable of various kinds, or the like. Among them, the plastic optical fiber is preferably used in terms of flexibility.

According to the optical communication cable of the present disclosure, since the photoelectric composite transmission module 1 according to the second aspect of the present disclosure is used as a photoelectric composite transmission module, the optical communication cable is reduced in thickness, size, and weight, implements the infallible protection of the photoelectric conversion unit 5, and is also excellent in durability.

In the above-mentioned Examples, specific modes of the present disclosure have been described, but the above-mentioned Examples are merely examples, and should not be construed in a limited manner. Various modifications that are obvious for those skilled in the art are intended to be within the scope of the present disclosure.

The photoelectric composite transmission module according to the present disclosure is excellent as a photoelectric composite transmission module that is reduced in thickness and weight.

### REFERENCE SIGNS LIST

1 Photoelectric composite transmission module
2 Hybrid cable
3 First housing
4 Second housing
5 Photoelectric conversion unit
6 Resin
6a Surface (of resin 6) facing first housing 3
7 Heat-transfer member
8 MT optical connector
9 PMT optical connector
10 ZIF connector
11 Plug
12 Light-emitting element
13 Drive integrated circuit (drive IC)
14 Light-receiving element
15 Trans impedance amplifier (TIA)
16 Optical waveguide
16a Under-cladding layer
16b Core layer
16c Over-cladding layer
16d Mirror
17 Substrate
17a First surface (of substrate 17)
17b Second surface (of substrate 17)
18 Photoelectric hybrid substrate
19 Case
20 Wiring pattern
21 Frame wall
22 PCB
r Virtual line
S Distance from first surface 17a to first housing 3
t Distance from first surface 17a to highest location of resin 6
u Distance from first surface 17a to highest location of photoelectric conversion unit 5
α Region
α₁ Area of region
A Height of frame wall
B Distance from internal surface of first housing 3 in region α to surface 6a of resin 6 facing first housing
C Distance from substrate 17 to surface 6a of resin 6 facing first housing
D Distance from internal surface of first housing 3 in region α to substrate 17
E Area when viewed from vertically above drive integrated circuit
F Area when viewed from vertically above photoelectric hybrid substrate
G Area when viewed from vertically above TIA
H First displacement portion
I Second displacement portion
J Facing distance on one end side
K Facing distance on the other end side

1. A photoelectric composite transmission module comprising:
a photoelectric hybrid substrate including:
a substrate;
a photoelectric conversion unit provided on a first surface of the substrate; and
an optical waveguide provided on a second surface of the substrate;
a first housing that protects one surface side of the photoelectric hybrid substrate, the one surface side corresponding to a surface of the photoelectric hybrid substrate on which the photoelectric conversion unit is provided;
a second housing that protects the other surface side of the photoelectric hybrid substrate, the other surface side corresponding to a surface of the photoelectric hybrid substrate on which the optical waveguide is provided; and
a heat-transfer member provided between the surface of the photoelectric hybrid substrate on which the photoelectric conversion unit is provided and the first housing,
wherein
the photoelectric conversion unit provided on the first surface of the substrate is covered with resin, and
a surface of the resin facing the first housing and the first housing are in contact with the heat-transfer member.

2. The photoelectric composite transmission module according to claim 1, wherein
the photoelectric hybrid substrate further includes a wiring pattern that transmits an electric signal from the photoelectric conversion unit or transmits an electric signal to the photoelectric conversion unit, and
the heat-transfer member is also in contact with at least part of the wiring pattern.

3. The photoelectric composite transmission module according to claim 1, wherein the heat-transfer member is in contact with a whole of the surface of the resin facing the first housing.

4. The photoelectric composite transmission module according to claim 1, wherein a surface of the first housing facing the photoelectric hybrid substrate is formed as a flat surface.

5. The photoelectric composite transmission module according to claim 1, wherein the photoelectric conversion unit on the photoelectric hybrid substrate includes a combination of a light-emitting element and a drive integrated circuit that drives the light-emitting element and/or a combination of a light-receiving element and a trans impedance amplifier.

6. The photoelectric composite transmission module according to claim 1, wherein the heat-transfer member is made of a material with heat conductivity of 20 W/mk or less.

7. The photoelectric composite transmission module according to claim 1, wherein the heat-transfer member is a heat dissipation sheet with an Asker C hardness of 40 or less.

8. The photoelectric composite transmission module according to claim 1, wherein an Asker C hardness P of the heat-transfer member, an Asker C hardness Q of the resin, and an Asker C hardness R of the photoelectric conversion unit are in a relationship shown in the following Expression (1)
$$P < Q < R . \qquad ( 1 )$$

9. The photoelectric composite transmission module according to claim 1, wherein each of the first housing and the second housing is made of metal.

10. An optical communication cable using the photoelectric composite transmission module according to claim 1, the optical communication cable comprising:
the photoelectric composite transmission module; and
a hybrid cable connected to the photoelectric composite transmission module.

11. A photoelectric composite transmission module comprising:
a photoelectric hybrid substrate including:
a substrate;
a photoelectric conversion unit provided on a first surface of the substrate; and
an optical waveguide provided on a second surface of the substrate;
a first housing that protects one surface side of the photoelectric hybrid substrate, the one surface side corresponding to a surface of the photoelectric hybrid substrate on which the photoelectric conversion unit is provided;
a second housing that protects the other surface side of the photoelectric hybrid substrate, the other surface side corresponding to a surface of the photoelectric hybrid substrate on which the optical waveguide is provided; and
a heat-transfer member provided between the surface of the photoelectric hybrid substrate on which the photoelectric conversion unit is provided and the first housing,
wherein
the photoelectric conversion unit provided on the first surface of the substrate is covered with resin,
a frame wall that serves as an installation guide for the heat-transfer member is provided on an internal surface of the first housing,
the heat-transfer member is installed in a region surrounded by the frame wall, and
a surface of the resin facing the first housing is in contact with the first housing via the heat-transfer member.

12. The photoelectric composite transmission module according to claim 11, wherein a height A of the frame wall and a distance B from the internal surface of the first housing in the region surrounded by the frame wall to the surface of the resin facing the first housing are designed to satisfy the following Expression (4)
$$0.2 \leq ( A / B ) \leq 0.7 . \qquad ( 4 )$$

13. The photoelectric composite transmission module according to claim 11, wherein a height A of the frame wall and a distance D from the internal surface of the first housing in the region surrounded by the frame wall to the substrate are designed to satisfy the following Expression (2)
$$0.1 \leq ( A / D ) \leq 0.5 . \qquad ( 2 )$$

14. The photoelectric composite transmission module according to claim 11, wherein a distance B from the internal surface of the first housing in the region surrounded by the frame wall to the surface of the resin facing the first housing and a distance C from the substrate to the surface of the resin facing the first housing are designed to satisfy the following Expression (3)
$$2 \leq ( B / C ) \leq 3. \qquad ( 3 )$$

15. The photoelectric composite transmission module according to claim 11, wherein a heat dissipation sheet with an Asker C hardness of 40 or less is used as the heat-transfer member.

16. The photoelectric composite transmission module according to claim 11, wherein
the photoelectric conversion unit includes a light-emitting element and a drive integrated circuit, and
the region surrounded by the frame wall on the internal surface of the first housing is provided in a portion of the photoelectric conversion unit facing at least the drive integrated circuit.

17. The photoelectric composite transmission module according to claim 16, wherein an area of the region surrounded by the frame wall on the internal surface of the first housing is designed to be 95% or more of an area when viewed from vertically above the drive integrated circuit in the photoelectric conversion unit and designed to be 110% or less of an area when viewed from vertically above the photoelectric hybrid substrate.

18. The photoelectric composite transmission module according to claim 11, wherein
the photoelectric conversion unit includes a light-receiving element and a trans impedance amplifier, and
the region surrounded by the frame wall on the internal surface of the first housing is provided in a portion of the photoelectric conversion unit facing at least the trans impedance amplifier.

19. The photoelectric composite transmission module according to claim 18, wherein an area of the region surrounded by the frame wall on the internal surface of the first housing is designed to be 95% or more of an area when viewed from vertically above the trans impedance amplifier in the photoelectric conversion unit and designed to be 110% or less of an area when viewed from vertically above the photoelectric hybrid substrate.

20. The photoelectric composite transmission module according to claim 11, wherein
an external thickness of a housing formed of the first housing and the second housing is designed to be different between a first end side and a second end side,
the first housing is provided with a first displacement portion to change a facing distance, and
the heat-transfer member is installed in the first displacement portion.

21. The photoelectric composite transmission module according to claim 20, wherein
the second housing is provided with a second displacement unit to change a facing distance, and
the second displacement unit is provided at a position facing the first displacement unit provided in the first housing.

22. An optical communication cable using the photoelectric composite transmission module according to claim 11, the optical communication cable comprising:
the photoelectric composite transmission module; and
a hybrid cable connected the photoelectric composite transmission module.
